(19) United States
(12) Patent Application Publication
(10) Pub. No.: US 2024/0340828 A1
(43) Pub. Date: Oct. 10, 2024

(54) TIMING ADJUSTMENT FOR UPLINK TRANSMISSION

(71) Applicant: Nokia Technologies Oy, Espoo (FI)

(72) Inventors: Alessio MARCONE, Munich (DE); Dmitry PETROV, Espoo (FI); Mohamad SAYED HASSAN, Massy (FR); Lars DALSGAARD, Oulu (FI)

(21) Appl. No.: 18/681,491

(22) PCT Filed: Aug. 6, 2021
(86) PCT No.: PCT/EP2021/072066

§ 371 Date: Feb. 5, 2024

(51) Int. Cl. H04W 56/00; H04B 7/08

(52) U.S. Cl. CPC H04W 56/0045; H04B 7/088

(57) ABSTRACT

Example embodiments of the present disclosure relate to timing adjustment for uplink transmission, particularly in a high-speed scenario. A first device receives, from a second device, offset information indicating a difference in propagation delays between the first device and a third device experienced by the second device. The offset information is determined based on a time shifting value for a range of the difference in propagation delays. The time shifting value is associated with a switch from a beam associated with the first device to a beam associated with the third device. The third device is different from the first device. The first device transmits, to the second device, timing information indicating an amount of timing advance for transmission from the second device to the third device. The timing information is determined based on the time shifting value. Through this solution. UL transmission will be timing aligned.

### FIELD

Embodiments of the present disclosure generally relate to the field of telecommunication and in particular, to methods, devices, apparatuses and computer readable storage medium for timing adjustment for uplink (UL) transmission, particularly in a high-speed scenario.

### BACKGROUND

In some communication systems, a terminal device may operate in a high-speed scenario, for example, the terminal device may be located on a high-speed train (HST). In addition, mm Wave/frequency range 2 (FR2) deployments may be used to provide additional network capacity in such high-speed scenario. In HST deployments in FR2, the terminal device may perform beam switching, which would cause some issues in timing adjustment for alignment with a network device on UL. It is desirable to resolve these issues such that the terminal device is alignment with the network device.

### SUMMARY

In general, example embodiments of the present disclosure provide a solution for timing adjustment for UL transmission, particularly in the high-speed scenario.

In a first aspect, there is provided a first device. The first device comprises at least one processor; and at least one memory including computer program code; where the at least one memory and the computer program code are configured to, with the at least one processor, cause the first device to receive, from a second device, offset information indicating a difference in propagation delays between the first device and a third device experienced by the second device, wherein the offset information is determined based on a time shifting value for a range of the difference in propagation delays, the time shifting value is associated with a switch from a beam associated with the first device to a beam associated with the third device, and the third device is different from the first device; and transmit, to the second device, timing information indicating an amount of timing advance for transmission from the second device to the third device, wherein the timing information is determined based on the time shifting value.

In a second aspect, there is provided a second device. The second device comprises at least one processor; and at least one memory including computer program code; where the at least one memory and the computer program code are configured to, with the at least one processor, cause the second device to obtain a time shifting value for a range of a difference in propagation delays experienced by the second device, wherein the time shifting value is associated with a switch from a beam associated with a first device to a beam associated with a third device, and the third device is different from the first device; transmit, to the first device, offset information indicating the difference in propagation delays between the first and third devices experienced by the second device, wherein the offset information is determined based on the time shifting value; and receive, from the first device, timing information indicating an amount of timing advance for transmission from the second device to the third device, wherein the timing information is determined based on the time shifting value.

In a third aspect, there is provided a fourth device. The fourth device comprises at least one processor; and at least one memory including computer program code; where the at least one memory and the computer program code are configured to, with the at least one processor, cause the fourth device to determine an amount of timing adjustment for transmission between the fourth device and a fifth device at least based on a difference in propagation delays between a source device and a target device involved in a beam switch; and perform the transmission with the fifth device based on the amount of timing adjustment.

In a fourth aspect, there is provided a method. The method comprises receiving, at a first device and from a second device, offset information indicating a difference in propagation delays between the first device and a third device experienced by the second device, wherein the offset information is determined based on a time shifting value for a range of the difference in propagation delays, the time shifting value is associated with a switch from a beam associated with the first device to a beam associated with the third device, and the third device is different from the first device; and transmitting, to the second device, timing information indicating an amount of timing advance for transmission from the second device to the third device, wherein the timing information is determined based on the time shifting value.

In a fifth aspect, there is provided a method. The method comprises obtaining, at a second device, a time shifting value for a range of a difference in propagation delays experienced by the second device, wherein the time shifting value is associated with a switch from a beam associated with a first device to a beam associated with a third device, and the third device is different from the first device; transmitting, to the first device, offset information indicating the difference in propagation delays between the first and third devices experienced by the second device, wherein the offset information is determined based on the time shifting value; and receiving, from the first device, timing information indicating an amount of timing advance for transmission from the second device to the third device, wherein the timing information is determined based on the time shifting value.

In a sixth aspect, there is provided a method. The method comprises determining, at a fourth device, an amount of timing adjustment for transmission between the fourth device and a fifth device at least based on a difference in propagation delays between a source device and a target device involved in a beam switch; and performing the transmission with the fifth device based on the amount of timing adjustment.

In a seventh aspect, there is provided a first apparatus. The first apparatus comprises means for receiving, from a second apparatus, offset information indicating a difference in propagation delays between the first apparatus and a third apparatus experienced by the second apparatus, wherein the offset information is determined based on a time shifting value for a range of the difference in propagation delays, the time shifting value is associated with a switch from a beam associated with the first apparatus to a beam associated with the third apparatus, and the third apparatus is different from the first apparatus; and means for transmitting, to the second apparatus, timing information indicating an amount of timing advance for transmission from the second apparatus to the third apparatus, wherein the timing information is determined based on the time shifting value.

In an eighth aspect, there is provided a second apparatus. The second apparatus comprises means for obtaining a time shifting value for a range of a difference in propagation delays experienced by the second apparatus, wherein the time shifting value is associated with a switch from a beam associated with a first apparatus to a beam associated with a third apparatus, and the third apparatus is different from the first apparatus; means for transmitting, to the first apparatus, offset information indicating the difference in propagation delays between the first and third apparatuses experienced by the second apparatus, wherein the offset information is determined based on the time shifting value; and means for receiving, from the first apparatus, timing information indicating an amount of timing advance for transmission from the second apparatus to the third apparatus, wherein the timing information is determined based on the time shifting value.

In a ninth aspect, there is provided a fourth apparatus. The fourth apparatus comprises means for determining an amount of timing adjustment for transmission between the fourth apparatus and a fifth apparatus at least based on a difference in propagation delays between a source apparatus and a target apparatus involved in a beam switch; and means for performing the transmission with the fifth apparatus based on the amount of timing adjustment.

In a tenth aspect, there is provided a computer readable medium. The computer readable medium comprises program instructions for causing an apparatus to perform at least the method according to any of the fourth, fifth and sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example scenario of uni-directional HST FR2 deployment;

FIG. 1B illustrates an example scenario of bi-directional HST FR2 deployment;

FIG. 2 illustrates an example diagram showing propagation delay at different distances from a specific remote radio head (RRH);

FIG. 3 illustrates an example communication environment in which example embodiments of the present disclosure may be implemented;

FIG. 4 illustrates a signaling chart showing an example process of timing adjustment according to some example embodiments of the present disclosure;

FIG. 5 illustrates an example shifted reporting range according to some example embodiments of the present disclosure;

FIG. 6 shows an example of timing advance according to some example embodiments of the present disclosure;

FIG. 7 illustrates a signaling chart showing another example process of timing adjustment according to some example embodiments of the present disclosure;

FIG. 8 illustrates an example diagram showing downlink (DL)/UL slot misalignment;

FIG. 9 illustrates a signaling chart showing a further example process of timing adjustment according to some example embodiments of the present disclosure;

FIG. 10 illustrates a flowchart of a method implemented at a first device according to some example embodiments of the present disclosure;

FIG. 11 illustrates a flowchart of a method implemented at a second device according to some example embodiments of the present disclosure;

FIG. 12 illustrates a flowchart of a method implemented at a fourth device according to some example embodiments of the present disclosure;

FIG. 13 illustrates a simplified block diagram of an apparatus that is suitable for implementing example embodiments of the present disclosure; and

FIG. 14 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As briefly mentioned above, mmWave/FR2 deployments are used as complimentary to provide additional network capacity in crowded areas with many users since high path loss in mmWave limits the coverage of the network cells. Therefore, FR2 deployments are usually dense with short distances between the network cells on the level of a few hundred meters.

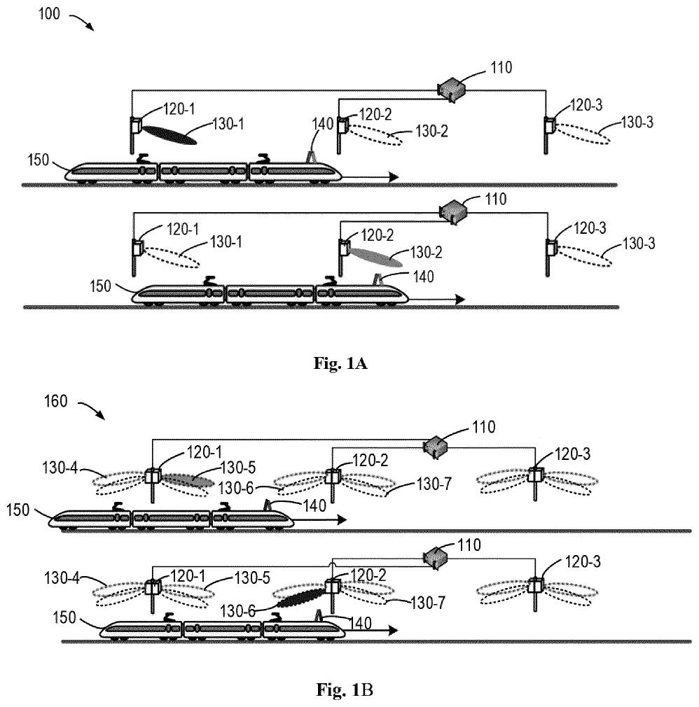

FIGS. 1A and 1B illustrate example scenarios 100 and 160 of HST in FR2 deployments. As shown in FIGS. 1A and 1B, a HST 150 and thus a roof-mounted CPE 140 located on the HST 150 may be traveling at a high-speed, for example a speed exceeding 350 km/h. A DU 110 may be equipped with a plurality of RRHs, for example, RRH 120-1, RRH 120-2 and RRH 120-3, which may be spaced along a track on which the HST 150 is traveling. The RRH 120-1, RRH 120-2 and RRH 120-3 may be collectively referred to as “RRHs 120” or individually referred to as a “RRH 120”. The RRHs 120 may belong to the substantially same cell of the DU 110. A distance between the RRHs 120, also referred to as the inter-RRH distance, may be a pre-determined distance, for example, a distance equal to 700 m.

The RRHs 120 are configured to provide beams for communication with the CPE 140 via the beams. In the unidirectional deployment as shown in FIG. 1A, the RRHs 120 provide beams in one direction, for example, the beam 130-1, beam 130-2 and beam 130-3. When the HST 150 is located at different locations of the track, the CPE 140 located on the HST 150 may perform transmission with several RRHs 120 via different beams 130. For example, when the HST 150 is moving in the direction shown by the arrow in FIG. 1A, the CPE 140 may initially perform transmission with the RRH 120-1 via the beam 130-1, and then perform transmission with the RRH 120-2 via the beam 130-2.

In the bi-directional deployment as shown in FIG. 1B, RRHs 120 may provide beams in two directions, for example the beam 130-4, beam 130-5, beam 130-6, beam 130-7 and so on. The beams 130-1, 130-2, 130-3, 130-4, 130-5, 130-6 and 130-7 may be collectively referred to as “beams 130” or individually referred to as a “beam 130”. When the HST 150 is moving in the direction shown by the arrow in FIG. 1B, the CPE 140 may initially perform transmission with the RRH 120-1 via the beam 130-5, and then perform transmission with the RRH 120-2 via the beam 130-7.

As shown in FIGS. 1A and 1B, the serving beam is switched from a RRH to another RRH for the CPE 140. In other words, the serving RRH is switched for the CPE 140. During beam switch or RRH switch, for example, if the serving beam is switched from one RRH 120 to the following RRH 120 due to mobility of the HST 150, the CPE 140 will stay anyway connected to the substantially same cell, since the RRHs 120 are connected to the substantially same DU 110.

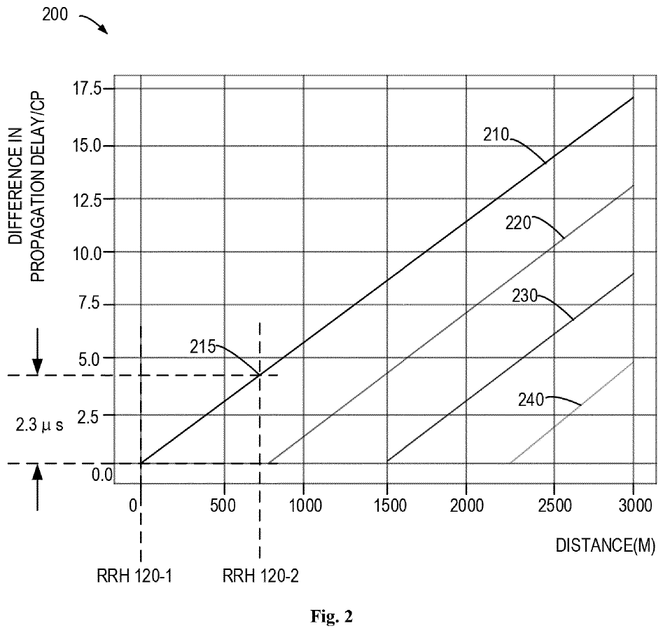

During beam switch or RRH switch, the large inter-RRH distances (for example 700m) will result in a significant difference in propagation delays between the neighboring RRHs. The significant difference in propagation delays may be on the level of a few micro-seconds. FIG. 2 shows an example diagram 200 of the difference in propagation delays over cyclic prefix (CP) length at different distances from a specific RRH. Plots 210, 220, 230 and 240 respectively illustrate the difference in propagation delays over CP length for RRH 120-1, RRH 120-2, RRH 120-3 and a farther RRH (not shown in FIGS. 1A and 1B). From the plot 210, the difference in propagation delays over CP length at the distance of 700 m between the RRH 120-1 and the RRH 120-2 is determined to be more than 4 at the intersection point 215. As such, a terminal device arrives at the coverage area of the RRH 120-2, the difference in propagation delays between the RRH 120-1 and the RRH 120-2 is roughly 5 times the CP length. For example, at 120 kHz subcarrier spacing (SCS), the CP length is equal to 0.57 μs. In this case, the difference in propagation delays between two RRHs with a distance of 700 m may be calculated as around 2.3 μs.

For 700 m inter-RRH distance, the difference in propagation delay between two signals from the two consecutive RRHs 120 would be around 2.3 μs which is much larger than the CP length. The large difference in propagation delay creates a limitation in terms of UL timing adjustment for UL timing alignment.

Conventionally, it has been proposed to apply timing advance (TA) to deal with the UL timing alignment. TA is the advance in time a UE applies to its UL transmission compared to the time at which the DL frame from the serving cell/RRH is received. In this way, the signal arriving at the gNB receiver is aligned with the start of the UL frame from gNB perspective. TA is needed for network operation and performance since it allows the gNB to synchronize the reception of multiple UEs to arrive at the gNB at the substantially same time. To control the UL transmission timing at the UE, Timing Advance Command (TAC) is used.

The TAC can be indicated in two ways. The TAC can be indicated through a Random Access Response (RAR) as a part of the random access (RA) procedure, which is associated to initial timing offset. When the UE is in radio resource control (RRC) connected mode, the TAC can be indicated through medium access control (MAC)-control element (CE), which is associated to residual timing offset. The TAC indicated through MAC-CE is used by the network to update the used TA in the UEs when needed. To this end, the gNB constantly measures, tracks and indicates to the UE when to compensate for its time-varying propagation delay due to movement by sending TA updates to the UE. To estimate the amount of TA a UE needs, the gNB constantly measures the time of arrival of UL channels (e.g., physical uplink shared channel (PUSCH)/physical uplink control channel (PUCCH)/Sounding Reference Signal (SRS)) compared to the actual start of the UL frame/slot.

The TAC is currently limited to 6 bits, which results in a maximum single-shot TA change of 2.1 μs. The TAC of 6 bits would not be enough to compensate completely for the difference in propagation delays between two RRHs in some deployment scenarios. Indeed, as also calculated above, for an inter-RRH distance of 700 m, a difference in propagation delays of 2.3 μs can be expected, giving a minimum error in timing advance of 0.2 μs (2.3 μs-2.1 μs) that affects UL receiver performance.

UL gNB receivers are typically designed to track a time offset between [−CP/2:CP/2] μs. Even assuming UE autonomous UL transmission timing tracking, an error beyond this range would create problems in estimation and compensation of such time offset.

In the example above, the expected time offset is ideally 0.2 μs, which is less than CP/2=0.29 μs and theoretically possible to compensate. However, a UE is allowed a timing error of 0.11 μs, resulting in a possible time offset at gNB receiver of 0.31 μs, which would become larger than CP/2 and would fall beyond the range supported by the time offset estimator. In addition, the inter-RRH distance of 700 m is used mostly as a reference value.

In practical deployments, longer distances can be present or needed, causing errors in timing advance larger than 0.31 μs.

In view of the foregoing, if conventional timing alignment mechanism is used, the following negative consequences are expected: The time offset at RRH switch is more than two times the CP length and the timing offset (TO) estimator of the network device is likely not designed to handle such large timing offset values. The network will hence not be able to estimate (and indicate to the terminal device) a proper TAC. Misaligned UL transmission timing will result in failure in decoding the UL at the network device side, leading to beam failure or in radio link failure. In this case, the terminal device will need to re-establish connection to the cell. The data transmission both in DL and in UL will be interrupted for a significant amount of time.

In another aspect, it has been proposed to report ΔTO by a UE to the network. ΔTO is defined as the difference in propagation delays between two adjacent RRHs experienced by a UE. The reporting of ΔTO can aid the network in tracking such difference.

The reporting of ΔTO is expected to be designed following the TAC framework and hence be characterized by and limited to a representation range of 6 bits. In such a case, there could be scenarios similar to the one mentioned above with respect to TAC, in which the 6 bits field would be limiting and not able to represent the actual amount of difference in propagation delays. As a result, the network will not know the actual difference in propagation delays, and network operation will be impacted.

However, these problems with TAC and ΔTO have not been considered so far for the following reasons. One reason is that mm Wave networks are usually considered not as stand-alone but in heterogeneous scenarios with available longer-distance FR1 coverage. Therefore, mm Wave inter-RRH distances are considerably shorter than currently considered in HST FR2 deployments. Second, the new radio (NR) beam switching procedure was developed based on the scenarios where the beams are not distributed but co-located. In HST deployments, it is beneficial to have larger cells for faster MAC-based intra-cell mobility instead of more frequent handovers (HOs) (i.e., when at least one RRH corresponds to an individual cell). Thus, the RA procedure is not involved at every RRH change, and larger TAs adjustments are needed. Therefore, there is needed to enhance timing adjustment for UL transmission particularly for the scenario of HST in FR2.

According to example embodiments of the present disclosure, there is proposed a solution for timing adjustment, and in particular for timing adjustment for UL transmission for HST in FR2. In this present disclosure, a solution about how to perform timing adjustment using a time shifting value for timing advance and difference in propagation delays is proposed. A terminal device receives from a source device (for example, a source RRH) a configuration indicating a time shifting value associated with a switch from the source device to the target device (for example, a target RRH). The terminal device determines offset information based on the time shifting value. The offset information indicates a difference in propagation delays between the source and target devices. The terminal device transmits the offset information to the source device as a report of the difference in propagating delay. The source device determines timing information indicating an amount of timing advance for transmission from the terminal device to the target device and transmits the timing information to the terminal device. Then, the terminal device performs transmission with the target device based on the timing information and the time shifting value.

By using the time shifting value, the offset information can be used to report the difference in propagation delays without extra overhead and the timing information can be used to indicate the timing advance without extra overhead. For example, the field for ΔTO and the field for TAC can be kept as 6 bits without extension. In other words, a large difference in propagation delays when switching RRH in an HST FR2 scenario can be represented and corrected with minimum or no additional signaling overhead for the TAC and the ΔTO reporting. In this way, it can be ensured that UL transmission is timing aligned.

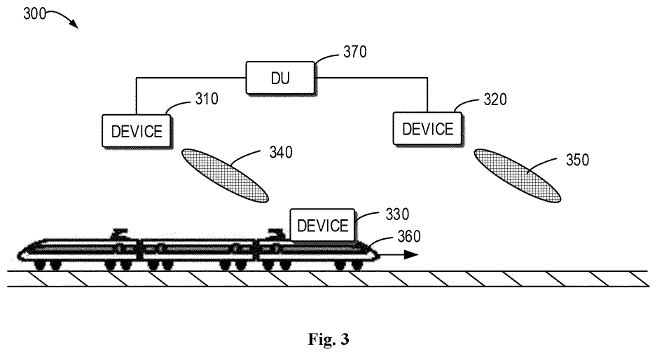

Principle and implementations of the present disclosure will be described in detail below with reference to FIGS. 3-14.

FIG. 3 shows an example communication environment 300 in which example embodiments of the present disclosure can be implemented. In the communication environment 300, a plurality of communication devices, including a device 310, a device 320, a device 330 and a DU 370, may communicate with each other.

In the example of FIG. 3, the device 310 and the device 320 are illustrated as network devices connected to the DU 370. For example, the device 310 and device 320 may be two adjacent RRHs. The devices 310 and 320 are located in the coverage of a cell provided by the DU 370. The devices 310 and 320 may each be associated with a plurality of beams within the cell. For example, the device 310 is associated with a beam 340, while the device 320 is associated with a beam 350.

The device 330 is illustrated as a terminal device served by the DU 370, for example by the device 310 or the device 320. For example, the device 330 may be a CPE or any other suitable device mounted on a HST 360. As another example, the device 330 may be a UE carried by a passenger on the HST 360. The device 330 may perform transmission with the device 310 via the beam 340 or perform transmission with the device 320 via the beam 350.

It is to be understood that although FIG. 3 illustrates unidirectional deployment as an example, the embodiments of the present disclosure can be applied to bi-directional deployment. It is to be understood that the number of devices and beams is only for the purpose of illustration without suggesting any limitations. The communication environment 300 may include any suitable number of devices and beams configured for implementing embodiments of the present disclosure. Although not shown, it is to be understood that one or more terminal devices may be located on the HST 360 and served by the devices connected to the DU 370. It is noted that although illustrated as a network device, the device 310 and the device 320 may be other device than a network device. Although illustrated as a terminal device, the device 330 may be other device than a terminal device.

In some example embodiments, if the device 330 is a terminal device and the devices 310 and 320 are network devices, a link from the device 310 or the device 320 to the device 330 is referred to as a DL, while a link from the device 330 to the device 310 or the device 320 is referred to as an UL. In DL, the devices 310 and 320 are transmitting (TX) devices (or transmitters) and the device 330 is a receiving (RX) device (or a receiver). In UL, the device 330 is a TX device (or a transmitter) and the devices 310 and 320 are RX devices (or a receivers).

Communications in the communication environment 300 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the example environment 300, serving device may be switched for the device 330. For example, serving RRH switch may occur for the device 330. Specifically, as the HST 360 is moving in the direction shown with the arrow, serving device for the device 330 is switched from the device 310 to the device 320. Initially, the device 330 may perform transmission with the device 310 via the beam 340. After entering the coverage area of the device 320, the device 330 may switch to perform transmission with the device 320 via the beam 350. In this case, timing adjustment is needed to ensure timing alignment of transmission from the device 330 to the device 320.

### Time Shifting Value

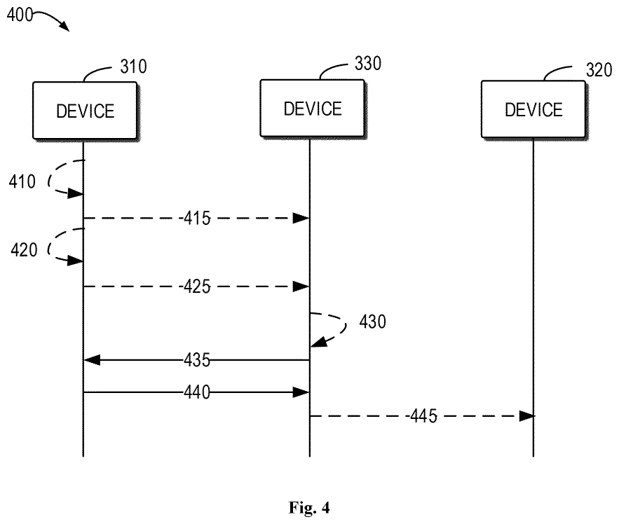

Reference is now made to FIG. 4. FIG. 4 shows a signaling chart 400 illustrating an example process of timing adjustment according to some example embodiments of the present disclosure. For the purpose of discussion, the signaling chart 400 will be described with reference to FIG. 3. The signaling chart 400 involves the device 310, the device 320 and the device 330 as illustrated in FIG. 3.

In operation, a time shifting value for a range of the difference in propagation delays, which also referred to as a shifting value M, is configured to the device 330. The shifting value M is associated with a switch from a beam associated with a device to another beam associated with another device. In some example embodiments, the shifting value M may be specific to a specific switch. For example, the shifting value M may be specific to the switch from the beam 340 to the beams 350. Alternatively, the shifting value M may be common to switches between devices located in the substantially same cell. For example, the shifting value M may be common to the switch from the beam 340 to the beam 350 and a switch from the beam 350 to another beam associated with another device (which is also connected to the DU 370) following the device 320. If the RRHs are distributed evenly along the track, the shifting value M may be common.

The shifting value M may be determined based on a deployment scenario of the network devices including the devices 310 and 320. Alternatively, or in addition, the shifting value M may be determined based on a distance between the devices 310 and 320.

In some example embodiments, the time shifting value may be configured dynamically. As shown in FIG. 4, the device 310 may determine 410 the time shifting value. In such example embodiments, the device 320 may be informed with the time shifting value from the DU 370 or from another device connected to the DU 370, and some or all other devices connected to the DU 370 may be informed with the time shifting value as well. The device 310 may transmit 415, to the device 330, a configuration indicating the time shifting value. For example, the device 310 may transmit 415 the time shifting value to the device 330 in a RRC message.

In some example embodiments, the time shifting value may be configured statically or semi-statically. The DU 370 or another device connected to the DU 370 may determine the time shifting value. For example, in uni-directional scenario, the time shifting value may be configured once for some or all the devices connected to the DU 370 including the devices 310 and 320. In such example embodiments, the time shifting value may be transmitted to the device 330 from the device 310. Alternatively, the time shifting value may be transmitted to the device 330 from another device connected to the DU 370, such as a device preceding the device 310 along the track.

In the case of a common time shifting value, the time shifting value may maintain the same unless major change happens, for example a distance between neighboring RRHs is changed. When major change happens, the DU 370 may re-configure the time shifting value for some or all the devices connected to the DU including the devices 310 and 320 and for some or all beams of these devices. Then, a source device which is performing transmission with the device 330 at that time may transmit the re-configured time shifting value to the device 330.

The device 330 may not use the time shifting value as soon as it receives the value. In other words, use of the time shifting value at the device 330 may need to be activated. The use of the time shifting value may include use of the time shifting value for transmission from the device 330 to the device 320, including the use in interpreting TAC. The use of the time shifting value may further include use of the time shifting value in reporting the difference in propagation delays between the device 310 and the device 320 experienced by the device 330, that is, reporting time offset ΔTO.

In some example embodiments, the use of the time shifting value may be activated in a network aided approach by an indication from the device 310. As shown in FIG. 4, the device 310 may determine 420 that the device 330 is approaching the device 320. For example, the device 310 may determine that the device 330 is approaching the device 320 based on the position signal of the device 330 and the location of the device 320. Alternatively, the DU 370 may determine that the device 330 is approaching the device 320 based on the position signal of the device 330 and the location of the device 320. The DU 370 may further inform the device 310 that the device 330 is approaching the device 320. The DU 370 may also inform the device 320 that device 330 is approaching the device 320.

If the device 330 is approaching the device 320, the device 310 may transmit 425, to the device 330, an indication (which is also referred to as a “first indication” or “activation indication”) for activating use of the time shifting value in the transmission from the device 330 to the device 320. The activation indication may be also used to activate use of the time shifting value in reporting the difference in propagation delays between the device 310 and the device 320 experienced by the device 330. In other words, with the activation indication, the time shifting value may be activated for interpretation of TAC and reporting of timing offset ΔTO. As mentioned above, ΔTO represents the difference of propagation delays between the device 310 and the device 320 experienced by the device 330. The activation indication may be transmitted to the device 330 via downlink control information (DCI) or MAC CE. Upon receiving the activation indication, the device 330 may determine 430 to activate the use of the time shifting value.

In addition or alternatively, in some example embodiments, the use of the time shifting value may be activated in an autonomous approach without the activation indication. The device 330 may autonomously determine 430 to activate the use of the time shifting value based on one or more criterion.

As an example, the device 330 may receive a first index of a first beam (for example, beam 340 as shown in FIG. 3) associated with the device 310 and a second index of a second beam (for example, beam 350 as shown in FIG. 3) associated with the device 320. A measurement of the difference in propagation delays on the first and second beams may be used to activate use of the time shifting value. If the difference in propagation delays measured on the first and second beams exceeds a threshold, the device 330 may determine that the use of the time shifting value is activated. For example, if the device 330 determines that measured ΔTO^{s} (which is ΔTO in second) exceeds a threshold in seconds, or a payload used to represent ΔTO exceeds a threshold size (e.g., 6 bits), the device 330 may determine that the use of the time shifting value is activated. In this case, after reporting the ΔTO exceeding the threshold, the device 330 may determine to use the time shifting value in the next reporting of ΔTO from the device 330 to the device 310. The device 310 activates the use of time shifting value in the timing information command send by device 310 to device 330 together with a second indication indicating to switch from the beam associated with the device 310 to the beam associated with the device 320. The threshold may be configured by the network, for example, the device 310 or the DU 370.

In such example embodiments, by the network aided approach or the autonomous approach, coordination in use of the time shifting value is achieved between the network and UE. In some deployment scenarios, for example, in more complex bi-directional deployments, such coordination is needed to avoid ambiguities in the reporting of ΔTO and the interpretation of TAC. In case where a RRH has multiple beams, it can be avoided that a UE applies the shifting value M to interpret the TAC at at least one beam switch, but rather it can be ensured that it is applied only when the serving RRH is changed.

After the device 330 determines that use of the time shifting value is activated either by the network aided approach or by the autonomous approach, the device 330 may use the time shifting value to interpret TAC for the next beam switch, which corresponds to RRH switch. For example, if use of the time shifting value is activated and the switch from the device 310 to the device 320 occurs, the device 330 may determine the amount of TA based on the time shifting value and the timing information such as TAC in 6 bits. Interpretation of the TAC will be described below in detail.

Different from interpretation of the TAC, once the device 330 determines that the use of the time shifting value is activated either by the network aided approach or by the autonomous approach, the time shifting value can be used to report the difference in propagation delay. For example, once the use of the time shifting value is activated, the device 330 may determine offset information (such as ΔTO in 6 bits) based on the time shifting value and the difference in propagation delays experienced by the device 330. The offset information is used to indicate to the network of the difference in propagation delays experienced by the device 330. It is to be understood that before the time shifting value is activated, the device 330 may determine offset information based on the difference in propagation delays.

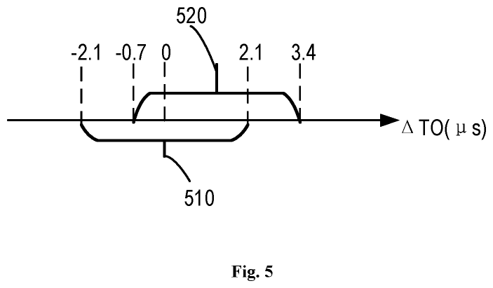

As an example, ΔTO may be represented by a number of bits equal to 6. That is, the value of ΔTO ranges from 0 to 63. The difference in propagation delays experienced by the device 330 in seconds may be represented by ΔTO^{s}, which is ΔTO in seconds. For example, before the time shifting value is activated, relation between ΔTO^{s} and ΔTO may be expressed using equation (1):

$$Δ T {O}^{s} = \frac{( Δ T O - 31 ) \cdot 16 \cdot 64}{{2}^{μ}} {T}_{c} \qquad ( 1 )$$

wherein T_{c} is equal to 0.509 ns, μ is equal to 3 in FR2 120 kHz SCS. By using equation (1), ΔTO^{s} may range from −2. 1 μs to 2. 1 μs (referred to as a symmetric range). FIG. 5 shows the range 510 of ΔTO^{s} ranging from −2.1 μs to 2.1 μs.

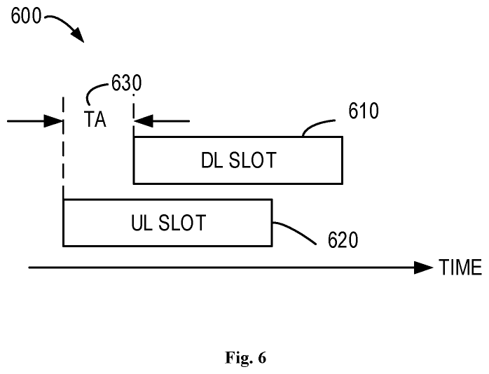

When the time shifting value is activated, the difference in propagation delays experienced by the device 330 in seconds may be represented by ΔTO_{M}^{s}, which is ΔTO in seconds. The relation between ΔTO_{M}^{s} and ΔTO may be expressed using equation (2) as below.

$$Δ {TO}_{M}^{s} = \frac{( M + Δ T O - 31 ) \cdot 16 \cdot 64}{{2}^{μ}} {T}_{c} \qquad ( 2 )$$

wherein T_{c} is equal to 0.509 ns, μ is equal to 3 in FR2 120 KHz SCS, and M represents the time shifting value. ΔTO in bits is reported to the device 310 as the difference in propagation delays. By using equation (2), ΔTO_{M}^{s} may have an asymmetric range. For example, when the time shifting value is equal to 20, ΔTO_{M}^{s} may range from −0.7 μs to 3.4 μs. FIG. 6 shows the range 620 of ΔTO_{M}^{s} ranging from −0.7 μs to 3.4 μs.

Using the time shifting value, ΔTO in 6 bits may represent the difference in propagation delays ranging from −0.7 μs to 3.4 μs. It can be seen from FIG. 6, a range of the difference in propagation delays indicated by the offset information is shifted based on the time shifting value as compared to the case without the time shifting value. In this way, it allows the device 330 to report a larger difference in propagation delays within 6 bits, for example, larger than 2.1 μs.

Reference is made back to FIG. 4. The device 330 transmits 435, to the device 310, offset information indicating a difference in propagation delays between the device 310 and the device 320 experienced by the device 330. The offset information (for example ΔTO in 6 bits) is determined based on the time shifting value. For example, the value of ΔTO may be determined by using the equation (2). The offset information (for example ΔTO in 6 bits) may be transmitted to the device 310 via PUCCH or PUSCH. In this way, the DU 370 or the device 310 may track the difference in propagation delays between the devices 310 and 320 in a larger range.

The device 310 transmits 440, to the device 330, timing information indicating an amount of TA for transmission from the device 330 to the device 320. The timing information, for example the TAC in 6 bits, is determined based on the time shifting value. The device 310 may transmit 440 the TAC in 6 bits to the device 330 via MAC CE.

In some example embodiments, the device 310 may transmit, to the device 330, an indication (which is also referred to as a “second indication” or a “switch indication”) of the switch together with the timing information. The switch indication indicates the device 330 to switch from a beam associated with the device 310 (for example, beam 340 shown in FIG. 3) to a beam associated with the device 320 (for example, beam 350 shown in FIG. 3).

After receiving the timing information from the device 310, the device 330 may perform interpretation of the TAC based on the time shifting value. As used herein, interpretation of the TAC means to determine the amount of TA used for transmission based on the TAC. For example, interpretation of the TAC may be performed based on the following equation (3):

$$T A = T {A}_{old} + \frac{( M + T A C - 31 ) \cdot 16 \cdot 64}{{2}^{μ}} {T}_{c} \qquad ( 3 )$$

wherein T_{c} is equal to 0.509 ns, μ is equal to 3 in FR2 120 KHz SCS, TA_{old} represents the existing TA the device 330 is applying to its UL transmission, M represents the time shifting value, and TAC is the value of bits comprised in the timing information (for example, timing advance command) with TAC=0, 1, 2, . . . , 63. By using equation (3), the device 330 may determine the value of TA based on the TAC in 6 bits and the time shifting value.

It is to be noted that before the time shifting value is activated, the device 330 may perform the interpretation of TAC without using the time shifting value. For example, the device 330 may determine the value of TA based on the equation (4) as below.

$$T A = T {A}_{old} + \frac{( T A C - 31 ) \cdot 16 \cdot 64}{{2}^{μ}} {T}_{c} \qquad ( 4 )$$

wherein T_{c} is equal to 0.509 ns, μ is equal to 3 in FR2 120 kHz SCS, TA_{old} represents the existing TA the device 330 is applying to its UL transmission, and TAC=0, 1, 2, . . . , 63. By using equation (4), the device 330 may determine the value of TA based on the TAC in 6 bits. As can be seen from a comparison of equations (3) and (4), the range of the timing advance is shifted based on the time shifting value.

The device 330 determines the amount of TA based on the timing information from the device 310. Once the device 330 determining to switch from the device 310 to the device 320, the device 330 may perform transmission from the device 330 to the device 320 by applying the determined amount of TA. For example, the device 330 may apply the determined amount of TA to a next UL transmission to the device 320 and perform 445 the next UL transmission to the device 320. The device 330 may apply the TA to UL transmissions such as PUSCH, PUCCH and SRS. FIG. 6 shows an example of applying TA at the device 330. As shown in FIG. 6, an amount of TA 630 is applied to the UL slot 620 compared to the time at which the DL slot 610 is received.

By shifting the range or the mean value of the difference in propagation delays and in the amount of timing advance, the terminal device is allowed to report a difference in propagation delays without extra overhead and the timing information can be used to indicate the timing advance without extra overhead. For example, the field for ΔTO and the field for TAC can be kept as 6 bits without extension. In other words, a large difference in propagation delays when switching RRH in an HST FR2 scenario can be represented and corrected with minimum or no additional signaling overhead for the TAC and the ΔTO reporting. In this way, it can be ensured that UL transmission is timing aligned.

### Compensation for the Transmission Misalignment

Some embodiments regarding shifting the time offset and the time advance have been described with reference to FIG. 4. In the example embodiments described with reference to FIG. 4, the reporting of ΔTO and the indication of TAC is limited, for example limited to 6 bits. Alternatively, in some example embodiments, the reporting of ΔTO is not a constraint. In other words, the network (for example, the DU 370, the device 310 and the device 320) has full knowledge of the difference in propagation delays experienced by the device 330. In such example embodiments, the problem of limited TAC range needs to be addressed such that the network will be able to instruct the device 330 to advance its UL transmission by an appropriate amount.

In such example embodiments, a device (for example, the device 330 or the device 320) involved in the beam switch may determine an amount of timing adjustment for transmission between the device 320 and the device 330 at least based on a difference in propagation delays between the device 310 acting as a source device and the device 320 acting as a target device. The source device refers to the device performing transmission with the device 330 before the beam switch. The target device refers to the device performing transmission with the device 330 after the beam switch. Then, the device may perform the transmission with the other device based on the determined amount of timing adjustment for transmission.

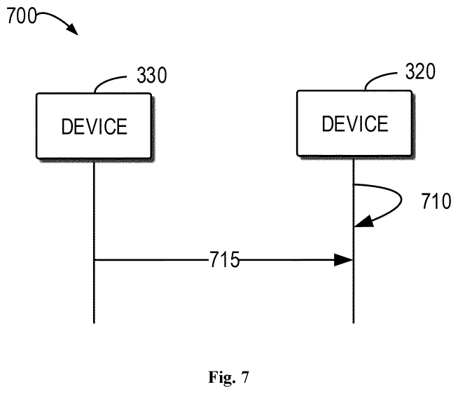

In some example embodiments, the device determining the amount of timing adjustment for transmission is the device 320 which acts as the target device. Reference is now made to FIG. 7, which shows another signaling chart 700 showing an example process of timing adjustment according to some example embodiments of the present disclosure. For the purpose of discussion, the signaling chart 700 will be described with reference to FIG. 3. The signaling chart 700 involves the device 320 and the device 330 as illustrated in FIG. 3.

In operation, the device 320 may determine 710 the amount of timing adjustment for the transmission between the device 330 and the device 320 based on the difference in propagation delays and an amount of TA indicating by a TAC. In this case, the device 320 (i.e., the target device) and the device 310 (i.e., the source device) know the value of ΔTO experienced by the device 330. TAC may be configured by the device 320. Alternatively, the TAC may be configured by the DU 370 for the device 320.

For example, the difference ε between the the difference in propagation delays ΔTO and the amount of TA indicating by the TAC may be determined using the equation (5) as below:

$$ε = Δ TO - TAC \qquad ( 5 )$$

where ΔTO and TAC may be in seconds and the difference ε is also in seconds. The amount of timing adjustment for the transmission may be determined as the difference ¿.

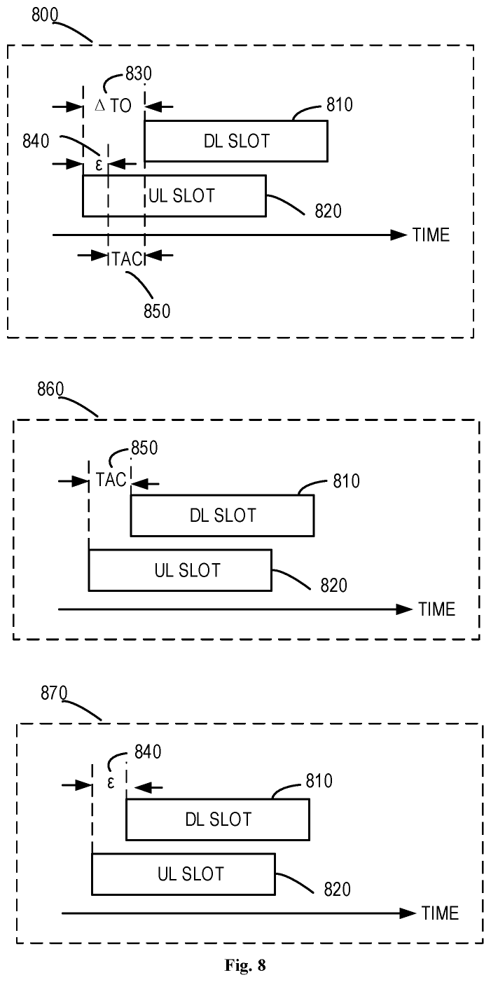

FIG. 8 illustrates an example diagram showing misalignment of DL slot 810 and UL slot 820. In FIG. 8, the example 800 shows ideal TA at the device 330. The difference of propagation delays is shown as ΔTO 830. The length of TAC 850 is shorter than the length of ΔTO 830 by a difference ε 840. Ideally, the device 330 should apply (TAC 850+difference ε 840) to the UL slot 820 to compensate the ΔTO 830.

However, actually, the device 330 may only apply the TAC 850 to the UL slot 820. The example 860 shows the actual TA at the device 330. The example 870 shows the residual misalignment at the device 330. As shown in example 870, the misalignment of ε 840 between the DL slot 810 and the UL slot 820 will still exist.

Reference is now made back to FIG. 7. As discussed above, if the device 330 applies TA indicated by the TAC for the transmission to the device 320, the misalignment of ε 840 between the DL slot 810 and the UL slot 820 will still exist. To deal with such misalignment, after determining the amount of timing adjustment for the transmission, the device 320 performs 715 the transmission with the device 330 based on the amount of timing adjustment for the transmission. For example, the device 330 may apply the difference ¿ as timing offset compensation. The device 330 may receive the UL slot and apply the timing offset compensation in time-domain or a frequency domain before any other processing. In this way, the target device may compensate for the UL transmission misalignment by applying the amount of timing adjustment for the transmission.

Alternatively, in some example embodiments, the device determining the amount of timing adjustment for transmission is the device 330. In some example embodiments, the device 320 may be aware of the difference ε, but does not compensate for it. The device 330 is allowed to perform the compensation based on an indication from the network.

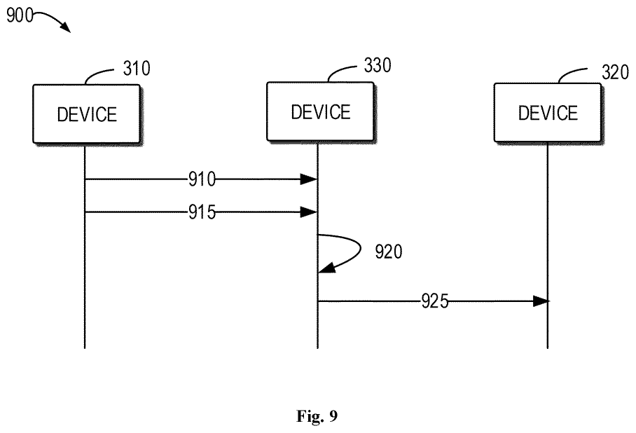

Reference is now made to FIG. 9, which shows another signaling chart 900 showing an example process of timing adjustment according to some example embodiments of the present disclosure. For the purpose of discussion, the signaling chart 900 will be described with reference to FIG. 3. The signaling chart 900 involves the device 310, the device 320 and the device 330 as illustrated in FIG. 3.

In operation, the device 310 may transmits 910, to the device 330, a TAC. For example, the amount of TA indicated by the TAC will be determined by the equation (6) as below:

$$T A = \frac{TAC \cdot 16 \cdot 64}{{2}^{μ}} {T}_{c} \qquad ( 6 )$$

wherein T_{c} is equal to 0.509 ns, μ is equal to 3 in FR2 120 kHz SCS, and TAC is equal to 0, 1, 2, . . . , 3846.

The device 310 may transmit 915, to the device 330, an indication (which is also referred to as “compensation indication”) indicating whether to activate timing offset compensation for the device 330. For example, the device 310 may transmit the indication via DCI or MAC CE to the device 330.

If the indication indicates to activate the timing offset compensation, the device 330 may determine 920 the difference in propagation delays between the device 310 and the device 320 experienced by the device 330 (such as ΔTO) as the amount of timing adjustment for transmission to the device 320. Then, the device 330 performs 925 the transmission with the device 320 based on the amount of timing adjustment. For example, the device 330 may apply the full ΔTO to the transmission to the device 320 as TA for the transmission. As an example, the compensation indication may be a flag. If the flag is set be true, the device 330 may apply the full ΔTO as TA for the transmission. In this way, the device 330 is allowed to use the full ΔTO in the next UL transmission(s) through dynamic explicit signaling.

If the indication indicates not to activate the timing offset compensation, the device 330 may perform the transmission to the device 330 by applying the amount of TA indicated by a TAC to the transmission. That is, the device 330 falls back to the default mode of timing advance. For example, if the flag is set be false, the device 330 may fall back to the default mode. In this way, when the difference ε is quite small or even equal to 0, the device 330 may simply apply the TA indicated by the TAC.

Several examples regarding determining the amount of TA based on the difference in propagation delays and the indication have been described above. Alternatively, in some example embodiments, the device 330 may determine the amount of timing adjustment for transmission based on the difference in propagation delays without the explicit compensation indication from the device 310.

In such example embodiments, if the difference in propagation delays experienced by the device 330 exceeds a threshold and an amount of TA indicated by the TAC is equal to a predefined value, the device 330 may determine the difference in propagation delays (such as the full ΔTO as the amount of timing adjustment for the transmission. For example, if ΔTO>63 and TA value comprised in the TAC is equal to 0, the device 330 applies the full ΔTO in seconds to the transmission to the device 320. In this case, the TA value in the TAC is ignored.

If the difference in propagation delays exceeds the threshold and the amount of TA is not equal to the predefined value, the device 330 may determine the amount of TA indicated by the TAC as the amount of timing adjustment for the transmission. For example, if ΔTO>63 and TA value comprised in the TAC is not equal to 0, the device 330 applies the TA value in the TAC to the transmission to the device 320. This is a fallback case in which the network does not support/activate the compensation at the UE and is able to compensate for the residual timing offset ε at the target RRH.

If the difference in propagation delays is below the threshold, the device 330 may determine the amount of TA indicated by the TAC as the amount of timing adjustment for the transmission. For example, if ΔTO<63, the device 330 applies the TA value in the TAC to the transmission to the device 320. That is, the device 330 falls back to the default mode.

In such example embodiments, the amount of timing adjustment for transmission is determined based on the difference in propagation delays and the TA value in TAC. In this way, the timing offset can be compensated by implicit signaling. It is to be understood that the above mentioned threshold and the predefined value may be any suitable values. For example, the threshold may be predefined as 63, and the predefined value may be equal to 0. It is to be understood that the example values of threshold and the predefined value are only for illustration without suggesting any limitations to the present disclosure.

By applying the amount of timing adjustment for compensation, it is possible to represent and correct for a large difference in propagation delays when switching RRH in an HST FR2 scenario with minimum or no additional signaling overhead for the TAC.

### Example Methods and Apparatuses

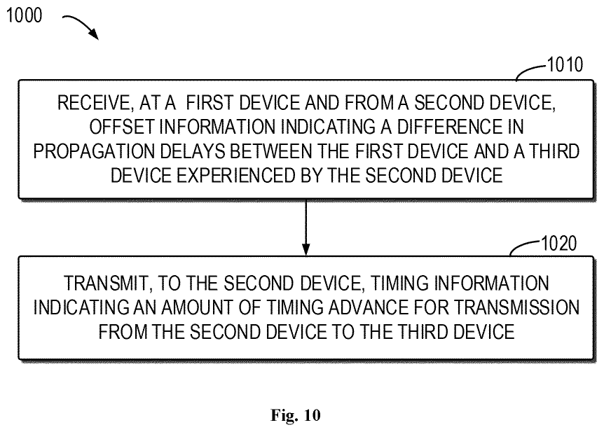

FIG. 10 shows a flowchart of an example method 1000 implemented at a first device (for example, the device 310) in accordance with some example embodiments of the present disclosure. For the purpose of discussion, the method 1000 will be described from the perspective of the device 310 with respect to FIG. 3.

At block 1010, the device 310 receives, from the device 330, offset information indicating a difference in propagation delays between the device 310 and the device 320 experienced by the device 330. The offset information is determined based on a time shifting value for a range of the difference in propagation delays. The time shifting value is associated with a switch from a beam associated with the device 310 to a beam associated with the device 320. The device 320 is different from the device 310.

At block 1020, the device 310 transmits, to the device 330, timing information indicating an amount of timing advance for transmission from the device 330 to the device 320. The timing information is determined based on the time shifting value.

In some example embodiments, in accordance with a determination that the device 330 is approaching the device 320, the device 310 may transmit, to the device 330, a first indication for activating use of the time shifting value in the transmission from the device 330 to the device 320.

In some example embodiments, the device 310 may transmit, to the device 330, a first index of the beam associated with the device 310 and a second index of the beam associated with the device 320 to activate use of the time shifting value in the transmission from the device 330 to the device 320.

In some example embodiments, the device 310 may transmit, to the device 330, a configuration indicating the time shifting value.

In some example embodiments, the device 310 may transmit, to the device 330, a second indication of the switch together with the timing information. The second indication indicates to switch from the beam associated with the device 310 to the beam associated with the device 320.

In some example embodiments, the device 310 may determine the time shifting value based on at least one of: a deployment scenario of the device 310 and the device 320, or a distance between the device 310 and the device 320.

In some example embodiments, the range of the difference in propagation delays indicated by the offset information is shifted based on the time shifting value as compared to the case without the time shifting value. In some example embodiments, the a range of the amount of timing advance indicated by the timing information is shifted based on the time shifting value as compared to the case without the shifting value.

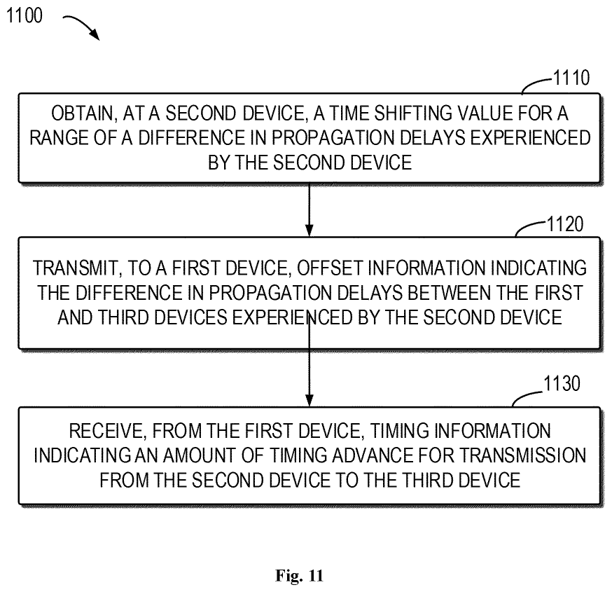

FIG. 11 shows a flowchart of an example method 1100 implemented at a second device (for example, the device 330) in accordance with some example embodiments of the present disclosure. For the purpose of discussion, the method 1100 will be described from the perspective of the device 330 with respect to FIG. 3.

At block 1110, the device 330 obtains a time shifting value for a range of a difference in propagation delays experienced by the device 330. The time shifting value is associated with a switch from a beam associated with the device 310 to a beam associated with the device 320. The device 320 is different from the device 310.

At block 1120, the device 330 transmits, to the device 310, offset information indicating the difference in propagation delays between the device 310 and the device 320 experienced by the device 330. The offset information is determined based on the time shifting value.

At block 1130, the device 330 receives, from the device 310, timing information indicating an amount of timing advance for transmission from the device 330 to the device 320. The timing information is determined based on the time shifting value.

In some example embodiments, in accordance with a determination that use of the time shifting value is activated, the device 330 may determine the offset information based on the time shifting value and the difference in propagation delays.

In some example embodiments, in accordance with a determination that use of the shifting value is activated and a determination of the switch from the device 310 to the device 320, the device 330 may determine the amount of timing advance based on the time shifting value and the timing information. The device 330 may perform the transmission from the device 330 to the device 320 by applying the amount of timing advance to the transmission.

In some example embodiments, the device 330 may receive, from the device 310, a first indication for activating use of the time shifting value in the transmission from the device 330 to the device 320. In response to receiving the first indication, the device 330 determines that the use of the time shifting value is activated.

In some example embodiments, the device 330 may receive, from the device 310, a first index of the beam associated with the device 310 and a second index of the beam associated with the device 320. In accordance with a determination that the difference in propagation delays measured on the first and second beams exceeds a threshold, the device 330 may determine that the use of the time shifting value is activated in the transmission from the device 330 to the device 320.

In some example embodiments, in obtaining the shifting value, the device 330 may receive from the device 310 a configuration indicating the time shifting value.

In some example embodiments, the device 330 may receive, from the device 310, a second indication of the switch together with the timing information. The second indication indicates to switch from the beam associated with the device 310 to the beam associated with the device 320.

In some example embodiments, a range of the difference in propagation delays indicated by the offset information is shifted based on the shifting value as compared to the case without the shifting value. In some example embodiments, a range of the amount of timing advance indicated by the timing information is shifted by based on the time shifting value as compared to the case without the time shifting value.

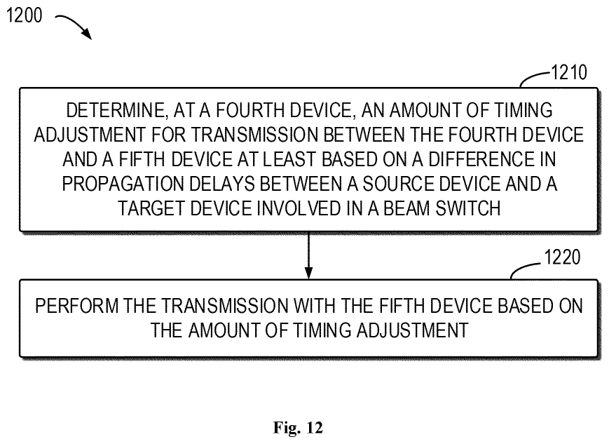

FIG. 12 shows a flowchart of an example method 1200 implemented at a fourth device in accordance with some example embodiments of the present disclosure. In some example embodiments, the fourth device may comprise the device 310. Alternatively, the fourth device may comprise the device 330. For the purpose of discussion, the method 1200 will be described from the perspective of the device 310 or the device 330 with respect to FIG. 3.

At block 1210, the fourth device determines an amount of timing adjustment for transmission between the fourth device and a fifth device at least based on a difference in propagation delays between a source device and a target device involved in a beam switch. At block 1220, the fourth device performs the transmission with the fifth device based on the amount of timing adjustment.

In some example embodiments, the fourth device may comprise the target device (for example the device 320) and the fifth device (for example the device 330) is to switch to the fourth device. In determining the amount of timing adjustment, the fourth device may determine the amount of timing adjustment for the transmission based on the difference in propagation delays and an amount of timing advance indicating by a timing advance command. In some example embodiments, in performing the transmission with the fifth device, the fourth device may apply the amount of timing adjustment to the transmission from the fifth device as timing offset compensation.

In some example embodiments, the fifth device may comprise the target device (for example the device 320) and the fourth device (for example the device 330) is to switch to the fifth device. In determining the amount of timing adjustment, the fourth device may receive, from the source device, an indication indicating whether to activate timing offset compensation for the fourth device. In accordance with a determination that the indication indicates to activate the timing offset compensation, the fourth device may determine the difference in propagation delays as the amount of timing adjustment for the transmission.

In some example embodiments, in performing the transmission with the fifth device, the fourth device may apply the amount of timing adjustment to the transmission to the fifth device as timing advance for the transmission. In some example embodiments, in accordance with a determination that the indication indicates not to activate the time offset compensation, the fourth device may perform the transmission to the fifth device by applying the amount of timing advance indicated by a timing advance command to the transmission.

In some example embodiments, the fifth device may comprise the target device (for example the device 320) and the fourth device (for example the device 330) is to switch to the fifth device. In determining the amount of timing adjustment, in accordance with a determination that the difference in propagation delays exceeds a threshold and an amount of timing advance indicated by a timing advance command is equal to a predefined value, the fourth device may determine the difference in propagation delays as the amount of timing adjustment for the transmission. In some example embodiments, in accordance with a determination that the difference in propagation delays exceeds the threshold and the amount of timing advance is not equal to the predefined value, the fourth device may determine the amount of timing advance as the amount of timing adjustment for the transmission. In some example embodiments, in accordance with a determination that the difference in propagation delays is below the threshold, the fourth device may determine the amount of timing advance as the amount of timing adjustment for the transmission. In some example embodiments, in performing the transmission with the fifth device, the fourth device may apply the amount of timing adjustment to the transmission to the fifth device as timing advance for the transmission.

In some example embodiments, a first apparatus capable of performing any of the method 1000 (for example, the device 310) may comprise means for performing the respective operations of the method 1000. The means may be implemented in any suitable form. For example, the means may be implemented in a circuitry or software module. The first apparatus may be implemented as or included in the device 310.

In some example embodiments, the first apparatus comprises: means for receiving, from a second apparatus, offset information indicating a difference in propagation delays between the first apparatus and a third apparatus experienced by the second apparatus, wherein the offset information is determined based on a time shifting value for a range of the difference in propagation delays, the time shifting value is associated with a switch from a beam associated with the first apparatus to a beam associated with the third apparatus, and the third apparatus is different from the first apparatus; and means for transmitting, to the second apparatus, timing information indicating an amount of timing advance for transmission from the second apparatus to the third apparatus, wherein the timing information is determined based on the time shifting value.

In some example embodiments, the first apparatus further comprises: means for in accordance with a determination that the second apparatus is approaching the third apparatus, transmitting, to the second apparatus, a first indication for activating use of the time shifting value in the transmission from the second apparatus to the third apparatus.

In some example embodiments, the first apparatus further comprises: means for transmitting, to the second apparatus, a first index of the beam associated with the first apparatus and a second index of the beam associated with the third apparatus to activate use of the time shifting value in the transmission from the second apparatus to the third apparatus.

In some example embodiments, the first apparatus further comprises: means for transmitting, to the second apparatus, a configuration indicating the time shifting value.

In some example embodiments, the first apparatus further comprises: means for transmitting, to the second apparatus, a second indication of the switch together with the timing information. The second indication indicates to switch from the beam associated with the first apparatus to the beam associated with the third apparatus.

In some example embodiments, the first apparatus further comprises: means for determining the time shifting value based on at least one of: a deployment scenario of the first apparatus and the third apparatus, or a distance between the first apparatus and the third apparatus.

In some example embodiments, the range of the difference in propagation delays indicated by the offset information is shifted based on the time shifting value as compared to the case without the time shifting value. In some example embodiments, the a range of the amount of timing advance indicated by the timing information is shifted based on the time shifting value as compared to the case without the shifting value.

In some example embodiments, a second apparatus capable of performing any of the method 1100 (for example, the device 330) may comprise means for performing the respective operations of the method 1100. The means may be implemented in any suitable form. For example, the means may be implemented in a circuitry or software module. The second apparatus may be implemented as or included in the first device 330.

In some example embodiments, the second apparatus comprises: means for obtaining a time shifting value for a range of a difference in propagation delays experienced by the second apparatus, wherein the time shifting value is associated with a switch from a beam associated with a first apparatus to a beam associated with a third apparatus, and the third apparatus is different from the first apparatus; means for transmitting, to the first apparatus, offset information indicating the difference in propagation delays between the first and third apparatuses experienced by the second apparatus, wherein the offset information is determined based on the time shifting value; and means for receiving, from the first apparatus, timing information indicating an amount of timing advance for transmission from the second apparatus to the third apparatus, wherein the timing information is determined based on the time shifting value.

In some example embodiments, the second apparatus further comprises: means for in accordance with a determination that use of the time shifting value is activated, determining the offset information based on the time shifting value and the difference in propagation delays.

In some example embodiments, the second apparatus further comprises: means for in accordance with a determination that use of the shifting value is activated and a determination of the switch from the first apparatus to the third apparatus, determining the amount of timing advance based on the time shifting value and the timing information; and means for performing the transmission from the second apparatus to the third apparatus by applying the amount of timing advance to the transmission.

In some example embodiments, the second apparatus further comprises: means for receiving, from the first apparatus, a first indication for activating use of the time shifting value in the transmission from the second apparatus to the third apparatus; and means for in response to receiving the first indication, determining that the use of the time shifting value is activated.

In some example embodiments, the second apparatus further comprises: means for receiving, from the first apparatus, a first index of the beam associated with the first apparatus and a second index of the beam associated with the third apparatus; and means for in accordance with a determination that the difference in propagation delays measured on the first and second beams exceeds a threshold, determining that the use of the time shifting value is activated in the transmission from the second apparatus to the third apparatus.

In some example embodiments, in obtaining the shifting value, the second apparatus further comprises: means for receiving, from the first apparatus a configuration indicating the time shifting value.

In some example embodiments, the second apparatus further comprises: means for receiving, from the first apparatus, a second indication of the switch together with the timing information. The second indication indicates to switch from the beam associated with the first apparatus to the beam associated with the third apparatus.

In some example embodiments, a range of the difference in propagation delays indicated by the offset information is shifted based on the shifting value as compared to the case without the shifting value. In some example embodiments, a range of the amount of timing advance indicated by the timing information is shifted by based on the time shifting value as compared to the case without the time shifting value.

In some example embodiments, a fourth apparatus capable of performing any of the method 1200 (for example, the device 310 or the device 330) may comprise means for performing the respective operations of the method 1200. The means may be implemented in any suitable form. For example, the means may be implemented in a circuitry or software module. The fourth apparatus may be implemented as or included in the device 310 or the device 330.

In some example embodiments, the fourth apparatus comprises: means for determining an amount of timing adjustment for transmission between the fourth apparatus and a fifth apparatus at least based on a difference in propagation delays between a source apparatus and a target apparatus involved in a beam switch; and means for performing the transmission with the fifth apparatus based on the amount of timing adjustment.

In some example embodiments, the fourth apparatus may comprise the target apparatus and the fifth apparatus is to switch to the fourth apparatus. In determining the amount of timing adjustment, the fourth apparatus further comprises means for determining the amount of timing adjustment for the transmission based on the difference in propagation delays and an amount of timing advance indicating by a timing advance command. In some example embodiments, in performing the transmission with the fifth device, the fourth apparatus further comprises means for applying the amount of timing adjustment to the transmission from the fifth device as timing offset compensation.

In some example embodiments, the fifth apparatus may comprise the target apparatus and the fourth apparatus is to switch to the fifth apparatus. In determining the amount of timing adjustment, the fourth apparatus further comprises means for receiving, from the source apparatus, an indication indicating whether to activate timing offset compensation for the fourth apparatus. In accordance with a determination that the indication indicates to activate the timing offset compensation, the fourth apparatus further comprises mean for determining the difference in propagation delays as the amount of timing adjustment for the transmission. In some example embodiments, in performing the transmission with the fifth apparatus, the fourth apparatus further comprises means for applying the amount of timing adjustment to the transmission to the fifth apparatus as timing advance for the transmission. In some example embodiments, in accordance with a determination that the indication indicates not to activate the time offset compensation, the fourth apparatus further comprises means for performing the transmission to the fifth apparatus by applying the amount of timing advance indicated by a timing advance command to the transmission.

In some example embodiments, the fifth apparatus may comprise the target apparatus and the fourth apparatus is to switch to the fifth apparatus. In determining the amount of timing adjustment, the fourth apparatus further comprises: means for in accordance with a determination that the difference in propagation delays exceeds a threshold and an amount of timing advance indicated by a timing advance command is equal to a predefined value, determining the difference in propagation delays as the amount of timing adjustment for the transmission. In some example embodiments, the fourth apparatus further comprises: means for in accordance with a determination that the difference in propagation delays exceeds the threshold and the amount of timing advance is not equal to the predefined value, determining the amount of timing advance as the amount of timing adjustment for the transmission. In some example embodiments, the fourth apparatus further comprises: means for in accordance with a determination that the difference in propagation delays is below the threshold, determining the amount of timing advance as the amount of timing adjustment for the transmission. In some example embodiments, in performing the transmission with the fifth apparatus, the fourth apparatus further comprises: means for applying the amount of timing adjustment to the transmission to the fifth device as timing advance for the transmission.

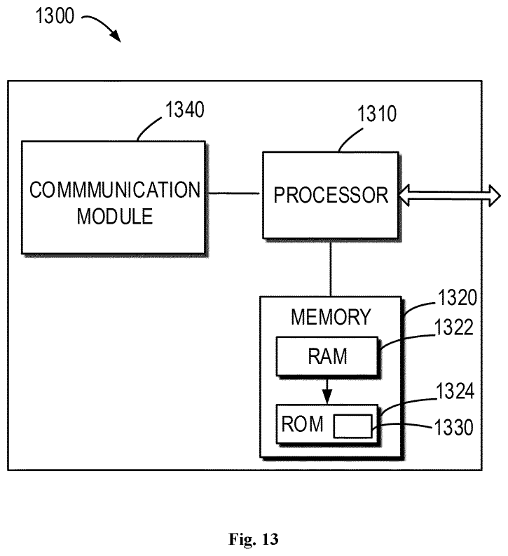

FIG. 13 is a simplified block diagram of a device 1300 that is suitable for implementing example embodiments of the present disclosure. The device 1300 may be provided to implement a communication device, for example, the device 310, the device 320 or the device 330 as shown in FIG. 3. As shown, the device 1300 includes one or more processors 1310, one or more memories 1320 coupled to the processor 1310, and one or more communication modules 1340 coupled to the processor 1310.

The communication module 1340 is for bidirectional communications. The communication module 1340 has one or more communication interfaces to facilitate communication with one or more other modules or devices. The communication interfaces may represent any interface that is necessary for communication with other network elements. In some example embodiments, the communication module 1340 may include at least one antenna.

The processor 1310 may be of any type suitable to the local technical network and may include one or more of the following: general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The memory 1320 may include one or more non-volatile memories and one or more volatile memories. Examples of the non-volatile memories include, but are not limited to, a Read Only Memory (ROM) 1324, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1322 and other volatile memories that will not last in the power-down duration.

A computer program 1330 includes computer executable instructions that are executed by the associated processor 1310. The program 1330 may be stored in the memory, e.g., ROM 1324. The processor 1310 may perform any suitable actions and processing by loading the program 1330 into the RAM 1322.

The example embodiments of the present disclosure may be implemented by means of the program 1330 so that the device 1300 may perform any process of the disclosure as discussed with reference to FIGS. 10 to 12. The example embodiments of the present disclosure may also be implemented by hardware or by a combination of software and hardware.

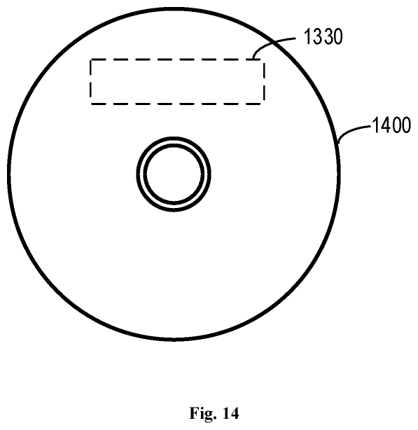

In some example embodiments, the program 1330 may be tangibly contained in a computer readable medium which may be included in the device 1300 (such as in the memory 1320) or other storage devices that are accessible by the device 1300. The device 1300 may load the program 1330 from the computer readable medium to the RAM 1322 for execution. The computer readable medium may include any types of tangible non-volatile storage, such as ROM, EPROM, a flash memory, a hard disk, CD, DVD, and the like. FIG. 14 shows an example of the computer readable medium 1400 which may be in form of CD, DVD or other optical storage disk. The computer readable medium has the program 1330 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIG. 4, FIG. 7, FIG. 9 and FIGS. 10-12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

The following abbreviations that may be found in the specification and/or the drawing figures are defined as follows:
CP Cyclic Prefix;
CPE Customer-Premises Equipment;
DCI Downlink Control Information;
DL Downlink;
DU Distributed Unit;
FR2 Frequency Range 2;
HO Handover;
HST High-Speed Train;
LTE Long Term Evolution;
MAC Medium Access Control;
MAC-CE Medium Access Control-Control Element;
NR New Radio;
PUCCH Physical Uplink Control Channel;
PUSCH Physical Uplink Shared Channel;
RA Random Access;
RAR Random Access Response;
RRC Radio Resource Control;
RRH Remote Radio Head;
SCS Subcarrier Spacing;
SRS Sounding Reference Signal;
TA Timing Advance;
TAC Timing Advance Command;
TO Timing Offset;
UE User Equipment;
UL Uplink.

1-54. (canceled)

55. A first device comprising:
at least one processor; and
at least one memory including computer program code;
wherein the at least one memory and the computer program code are configured to, with the at least one processor, cause the first device to:
receive, from a second device, offset information indicating a difference in propagation delays between the first device and a third device experienced by the second device, wherein the offset information is determined based on a time shifting value for a range of the difference in propagation delays, the time shifting value is associated with a switch from a beam associated with the first device to a beam associated with the third device, and the third device is different from the first device; and
transmit, to the second device, timing information indicating an amount of timing advance for transmission from the second device to the third device, wherein the timing information is determined based on the time shifting value.

56. The first device of claim 55, wherein the at least one memory and the computer program code are configured to, with the at least one processor, further cause the first device to: in accordance with a determination that the second device is approaching the third device, transmit, to the second device, a first indication for activating use of the time shifting value in the transmission from the second device to the third device.

57. The first device of claim 55, wherein the at least one memory and the computer program code are configured to, with the at least one processor, further cause the first device to: transmit, to the second device, a first index of the beam associated with the first device and a second index of the beam associated with the third device to activate use of the time shifting value in the transmission from the second device to the third device.

58. The first device of claim 55, wherein the at least one memory and the computer program code are configured to, with the at least one processor, further cause the first device to: transmit, to the second device, a configuration indicating the time shifting value.

59. The first device of claim 55, wherein the at least one memory and the computer program code are configured to, with the at least one processor, further cause the first device to: transmit, to the second device, a second indication of the switch together with the timing information, the second indication indicating to switch from the beam associated with the first device to the beam associated with the third device.

60. The first device of claim 55, wherein the at least one memory and the computer program code are configured to, with the at least one processor, further cause the first device to: determine the time shifting value based on at least one of:
a deployment scenario of the first and third devices, or
a distance between the first and third devices.

61. The first device of claim 55, wherein the range of the difference in propagation delays indicated by the offset information is shifted based on the time shifting value as compared to the case without the time shifting value, and
wherein a range of the amount of timing advance indicated by the timing information is shifted based on the time shifting value as compared to the case without the shifting value.

62. A second device comprising:
at least one processor; and
at least one memory including computer program code;
wherein the at least one memory and the computer program code are configured to, with the at least one processor, cause the second device to:
obtain a time shifting value for a range of a difference in propagation delays experienced by the second device, wherein the time shifting value is associated with a switch from a beam associated with a first device to a beam associated with a third device, and the third device is different from the first device;
transmit, to the first device, offset information indicating the difference in propagation delays between the first and third devices experienced by the second device, wherein the offset information is determined based on the time shifting value; and
receive, from the first device, timing information indicating an amount of timing advance for transmission from the second device to the third device, wherein the timing information is determined based on the time shifting value.

63. The second device of claim 62, wherein the at least one memory and the computer program code are configured to, with the at least one processor, further cause the second device to:
in accordance with a determination that use of the time shifting value is activated, determine the offset information based on the time shifting value and the difference in propagation delays.

64. The second device of claim 62, wherein the at least one memory and the computer program code are configured to, with the at least one processor, further cause the second device to:
in accordance with a determination that use of the shifting value is activated and a determination of the switch from the first device to the third device, determine the amount of timing advance based on the time shifting value and the timing information; and
perform the transmission from the second device to the third device by applying the amount of timing advance to the transmission.

65. The second device of claim 63, wherein the at least one memory and the computer program code are configured to, with the at least one processor, further cause the second device to:
receive, from the first device, a first indication for activating use of the time shifting value in the transmission from the second device to the third device; and
in response to receiving the first indication, determine that the use of the time shifting value is activated.

66. A fourth device comprising:
at least one processor; and
at least one memory including computer program code;
wherein the at least one memory and the computer program code are configured to, with the at least one processor, cause the fourth device to:
determine an amount of timing adjustment for transmission between the fourth device and a fifth device at least based on a difference in propagation delays between a source device and a target device involved in a beam switch; and
perform the transmission with the fifth device based on the amount of timing adjustment.

67. The fourth device of claim 66, wherein the fourth device comprises the target device and the fifth device is to switch to the fourth device, and
wherein the at least one memory and the computer program code are configured to, with the at least one processor, cause the fourth device to determine the amount of timing adjustment by:
determining the amount of timing adjustment for the transmission based on the difference in propagation delays and an amount of timing advance indicating by a timing advance command.

68. The fourth device of claim 67, wherein the at least one memory and the computer program code are configured to, with the at least one processor, cause the fourth device to perform the transmission with the fifth device by:
applying the amount of timing adjustment to the transmission from the fifth device as timing offset compensation.

69. The fourth device of claim 66, wherein the fifth device comprises the target device and the fourth device is to switch to the fifth device, and
wherein the at least one memory and the computer program code are configured to, with the at least one processor, cause the fourth device to determine the amount of timing adjustment by:
receiving, from the source device, an indication indicating whether to activate timing offset compensation for the fourth device; and
in accordance with a determination that the indication indicates to activate the timing offset compensation, determining the difference in propagation delays as the amount of timing adjustment for the transmission.

70. The fourth device of claim 69, wherein the at least one memory and the computer program code are configured to, with the at least one processor, cause the fourth device to perform the transmission with the fifth device by:
applying the amount of timing adjustment to the transmission to the fifth device as timing advance for the transmission.

71. The fourth device of claim 69, wherein the at least one memory and the computer program code are configured to, with the at least one processor, further cause the fourth device to:
in accordance with a determination that the indication indicates not to activate the time offset compensation, perform the transmission to the fifth device by applying the amount of timing advance indicated by a timing advance command to the transmission.

72. The fourth device of claim 66, wherein the fifth device comprises the target device and the fourth device is to switch to the fifth device, and
wherein the at least one memory and the computer program code are configured to, with the at least one processor, cause the fourth device to determine the amount of timing adjustment by:
in accordance with a determination that the difference in propagation delays exceeds a threshold and an amount of timing advance indicated by a timing advance command is equal to a predefined value, determining the difference in propagation delays as the amount of timing adjustment for the transmission.

73. The fourth device of claim 72, wherein the at least one memory and the computer program code are configured to, with the at least one processor, further cause the fourth device: in accordance with a determination that the difference in propagation delays exceeds the threshold and the amount of timing advance is not equal to the predefined value, determine the amount of timing advance as the amount of timing adjustment for the transmission.

74. The fourth device of claim 72, wherein the at least one memory and the computer program code are configured to, with the at least one processor, further cause the fourth device: in accordance with a determination that the difference in propagation delays is below the threshold, determine the amount of timing advance as the amount of timing adjustment for the transmission.
